(19) United States
(12) Patent Application Publication
(10) Pub. No.: US 2015/0056969 A1
(43) Pub. Date: Feb. 26, 2015

(54) ELECTRONIC DEVICE AND METHOD FOR CONTROLLING COMMUNICATION NOTIFICATIONS OF THE ELECTRONIC DEVICE

(71) Applicant: Chiun Mai Communication Systems, Inc., New Taipei (TW)

(72) Inventor: HSIN-YUNG SHAO, New Taipei (TW)

(21) Appl. No.: 14/465,198

(22) Filed: Aug. 21, 2014

(30) Foreign Application Priority Data
Aug. 22, 2013 (CN) 2013103680515

(51) Int. Cl. H04M 3/436; H04M 1/725; H04W 4/16; H04W 8/18; H04W 4/12

(52) U.S. Cl. CPC H04M 3/436; H04W 8/183; H04W 4/12; H04W 4/16; H04M 1/72597
USPC 455/415; 455/566

(57) ABSTRACT

In a method for controlling communication notification of an electronic device, an address book is searched for confirming identity information of a sender device when the electronic device receives a communication notification of the sender device. Voice data of the sender device corresponding to the confirmed identity information of the sender device using a voice is confirmed. A preset voice prompt of the communication notification is outputted via an earphone of the electronic device according to the confirmed voice data and a preset prompt ring corresponding to the communication notification. If a preset stop command triggered by the earphone is received, the electronic device is controlled to stop outputting of the preset voice prompt of the communication notification via the earphone.

### CROSS-REFERENCE TO RELATED APPLICATIONS

This application claims priority to Chinese Patent Application No. 201310368051.5 filed on Aug. 22, 2013 in the State Intellectual Property Office of the People's Republic of China, the contents of which are incorporated by reference herein.

### FIELD

Embodiments of the present disclosure relate to communication controlling technology, and particularly to an electronic device and a method for controlling communication notifications of the electronic device.

### BACKGROUND

Most electronic devices (for example, mobile phones) can use an earphone to output music or sounds. The earphone also can be used to control specified operations (for example, answering phone calls or starting and stopping music) of the electronic devices. When a user is listening to music using the earphone and the electronic device receives a communication notification (for example, an incoming call or a short message), the user may first need to check the communication notification, which may be displayed on a display screen to determine a sender of the communication notification, and to determine how to process the communication notification.

### BRIEF DESCRIPTION OF THE DRAWINGS

Implementations of the present disclosure will be described, by way of example only, with reference to the following drawings. The modules in the drawings are not necessarily drawn to scale, the emphasis instead being placed upon clearly illustrating the principles of the present disclosure. Moreover, in the drawings, like reference numerals designate corresponding portions throughout the views.

FIG. 1 is a block diagram of one embodiment of an electronic device including a communication notification control system.

FIG. 2 is a block diagram of one embodiment of the communication notification control system of the electronic device of FIG. 1.

FIG. 3 is a flowchart of one embodiment of a method of controlling communication notifications of the electronic device in FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references can mean “at least one,” or “one or more.” It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

In the present disclosure, “module,” refers to logic embodied in hardware or firmware, or to a collection of software instructions, written in a program language. In one embodiment, the program language can be Java, C, or assembly. One or more software instructions in the modules can be embedded in firmware, such as in an erasable programmable read only memory (EPROM). The modules described herein can be implemented as either software and/or hardware modules and can be stored in any type of non-transitory computer-readable media or storage medium. Non-limiting examples of a non-transitory computer-readable medium include CDs, DVDs, flash memory, and hard disk drives. The term “comprising” means “including, but not necessarily limited to”; it specifically indicates open-ended inclusion or membership in a so-described combination, group, series and the like.

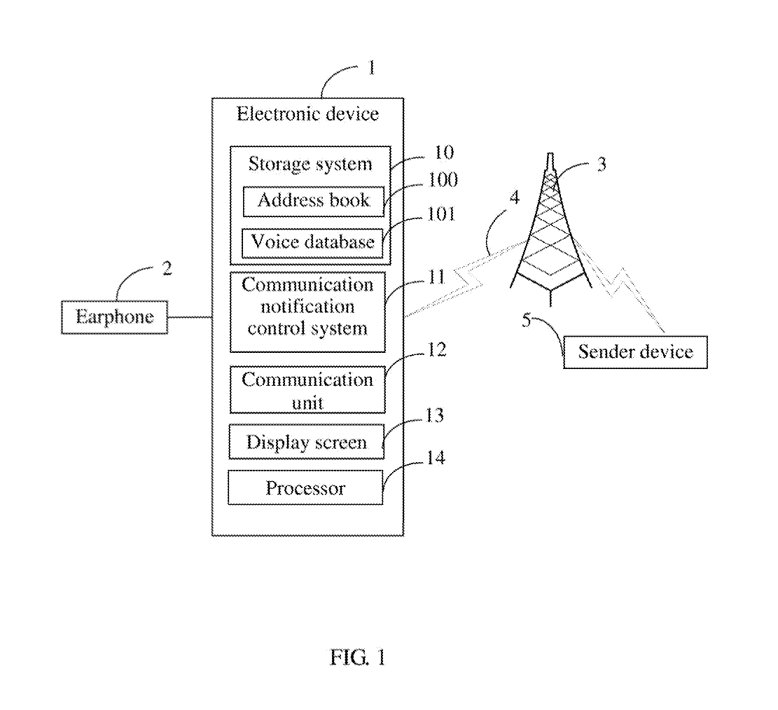

FIG. 1 is a block diagram of one embodiment of an electronic device including a communication notification control system. In one embodiment, the electronic device 1 can be a mobile phone, a tablet computer, or any other electronic device. The electronic device 1 further includes, but is not limited to, a storage system 10, a communication notification control system 11, a communication unit 12, a display screen 13, and at least one processor 14. The storage system 10 can store an address book 100 and a voice database 101. The address book 100 records names, phones numbers and other related information corresponding to different contacts. The voice database 101 stores voice files corresponding to numbers including 0-9 and different characters. In one embodiment, the voice database 101 further stores name-voice files corresponding to different names (for example, English names).

When the electronic device 1 receives a communication notification, the electronic device 1 can display a preset notification interface on the display screen 13 corresponding to the communication notification, for prompt a user of the electronic device 1 that the electronic device 1 has received the communication notification. The electronic device 1 communicates with other electronic devices using the communication unit 12.

The at least one processor 14 executes one or more computerized codes and other applications of the electronic device 1 to provide functions of the communication notification control system 11. The storage system 10 can be a memory of the electronic device 1 or an external storage card, such as a smart media card or a secure digital card.

The electronic device 1 can communicate with a base station 3 through a network 4 and the communication unit 12. The base station 3 transmits the communication notifications of the electronic device 1 through the network 4 to the communication unit 12. The electronic device 1 can communicate with a sender device 5 connected to the base station 3 through the network 4. In one embodiment, the electronic device 1 further includes an earphone 2 which is wired or wirelessly connected to the electronic device 1. The earphone 2 can include different keystrokes or virtual icons. The earphone 2 can trigger a preset stop command using a specified keystroke or icon, or by a combination of keystrokes or irons of the earphone 2. The earphone 2 can further trigger a preset start command for answering a phone call or play music of the electronic device 1, or trigger a preset end command for disconnecting the phone call or stop the playing of the music. In other embodiments, the earphone 2 can trigger other commands for controlling the electronic device 1. In one embodiment, the communication notification control system 11 can prompt the communication notification for the user using the earphone 2 by playing the voice files.

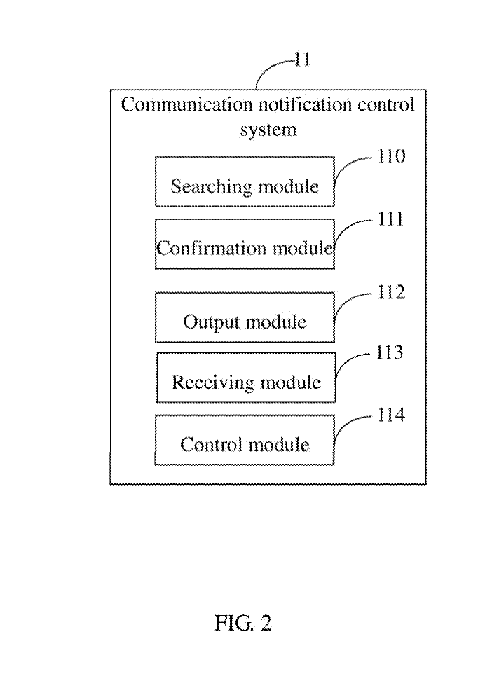

FIG. 2 is a block diagram of one embodiment of the communication notification control system of the electronic device of FIG. 1. In this embodiment, the communication notification control system 11 includes, but is not limited to, a searching module 110, a confirmation module 111, an output module 112, a receiving module 113, and a control module 114. The modules 110-114 include computerized code in the form of one or more programs that are stored in the storage system 10. The computerized code includes instructions that are executed by the at least one processor 14 to provide functions of the communication notification control system 11.

When the communication unit 12 receives a communication notification of the sender device 5 from the base station 3, the searching module 110 searches the address book 100 for confirming identity information of the sender device 5. In one embodiment, the searching module 110 extracts a phone number of the sender device 5 from the communication notification, and compares the extracted phone number with phone numbers in the address book 100. The searching module 110 further determines whether the extracted phone number matches a specified phone number in the address book 100. If the extracted phone number matches the specified phone number, the searching module 110 confirms a name corresponding to the specified phone number in the address book 100 as the identity information of the sender device 5. If no phone number in the address book 100 matches the extracted phone number, the searching module 110 confirms the extracted phone number as the identity information of the sender device 5.

The confirmation module 111 confirms voice data of the sender device 5 corresponding to the confirmed identity information of the sender device 5. In one embodiment, the confirmation module 111 confirms the voice data using the voice database 101. In other embodiments, the confirmation module 111 can further confirm voice data of content of the communication notification when the communication notification is a short message notification.

The output module 112 outputs a preset voice prompt of the communication notification via the earphone 2 according to the confirmed voice data and a preset prompt ring corresponding to the communication notification. The preset voice prompt includes outputting the voice data of the of the sender device 5 and preset voice keywords of the communication notification with the preset prompt ring corresponding to the communication notification. For example, if an incoming call notification is received from the sender device 5 with the name of “Lucy”, the output module 112 can outputs the voice data of “Lucy's incoming call” with a preset ring of the incoming call. In other embodiments, if the communication notification is the short message notification, the preset voice prompt can include outputting the voice data of the content of the short message.

When the user hears the preset voice prompt of the communication notification using the earphone 2, the user can operate the keystrokes or the virtual icons of the earphone 2 for executing corresponding commands to process the communication notification. The user also can process the communication notification by operating components (for example, an input unit or the display screen 13) of the electronic device 1.

The receiving module 113 receives commands triggered by the electronic device 1, and determines whether the electronic device 1 receives a preset stop command triggered by the earphone 2.

When the electronic device 1 receives the preset stop command , the control module 114 controls the electronic device 1 stop outputting of the preset voice prompt of the communication notification via the earphone 2 and returns to an original status of the electronic device 1. In one embodiment, the control module 114 can exit a preset notification interface of the communication notification displayed on the display screen 13, and returns the original status before displaying the preset notification interface. In other embodiments, the control module 114 can further send a preset message to the sender device 5 after receiving the preset stop command.

If the electronic device 1 does not receive the preset stop command, but receives other commands from the earphone 2 or the electronic device 1, the electronic device 1 can process the communication notification according to the received commands. If the electronic device 1 does not receive any command, the preset voice prompt can be played for a preset time period, such as 5 seconds, for example.

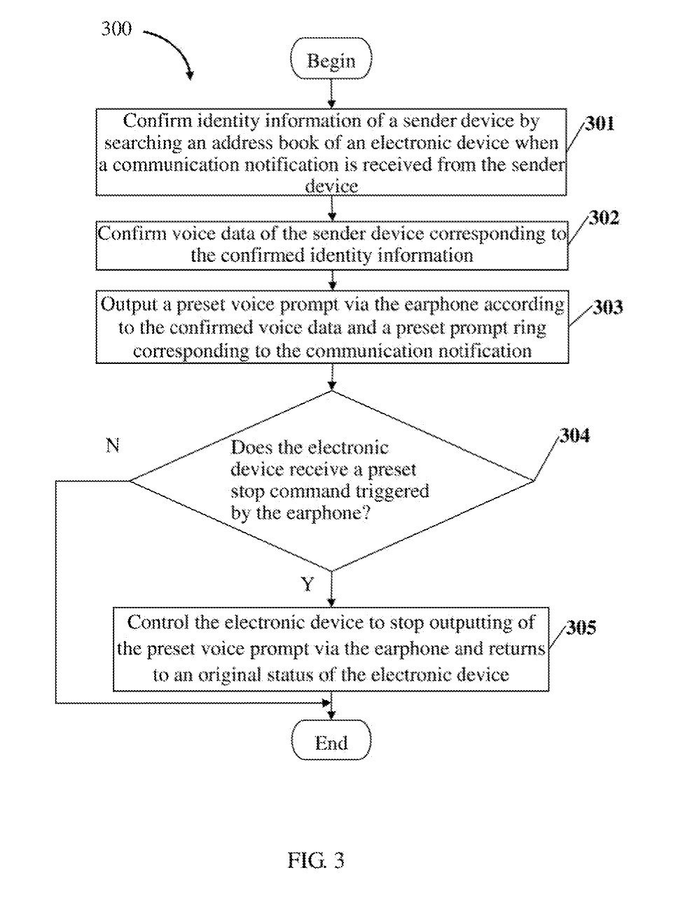

FIG. 3 is a flowchart of one embodiment of a method 300 for controlling communication notification of an electronic device. Depending on the embodiment, additional blocks can be added, others removed, and the ordering of the blocks can be changed. In the embodiment, the method 300 is performed by execution of computer-readable software program codes or instructions by at least one processor of a computing device. The method 300 is provided by way of example, as there are a variety of ways to carry out the method. The method 300 described below can be carried out using the configurations illustrated in FIG. 1-FIG. 2, for example, and various elements of these figures are referenced in explaining method 300. Each block shown in FIG. 3 represents one or more processes, methods or subroutines, carried out in the method 300. Additionally, the illustrated order of blocks is by example only and the order of the blocks can change according to the present disclosure. The example method 300 can begin at block 301.

In block 301, the searching module searches the address book 100 for confirming identity information of the sender device 5 when the communication unit 12 receives a communication notification of the sender device 5 from the base station 3. When the electronic device 1 receives the communication notification, the electronic device 1 can display a preset notification interface on the display screen 13 corresponding to the communication notification.

In one embodiment, if the extracted phone number matches a specified phone number in the address book 100, the searching module confirms a name corresponding to the specified phone number in the address book 100 as the identity information of the sender device 5. If no phone number in the address book 100 matches the extracted phone number, the searching module confirms the extracted phone number as the identity information of the sender device 5.

In block 302, the confirmation module confirms voice data of the sender device 5 corresponding to the confirmed identity information of the sender device 5. In one embodiment, the confirmation module confirms the voice data using voice files corresponding to the confirmed identity information in the voice database 101.

In block 303, the output module outputs a preset voice prompt of the communication notification via the earphone 2 according to the confirmed voice data and a preset prompt ring corresponding to the communication notification. The preset voice prompt includes outputting the voice data of the of the sender device 5 and preset voice keywords of the communication notification with the preset prompt ring corresponding to the communication notification.

In block 304, the receiving module receives commands triggered by the electronic device 1, and determines whether the electronic device 1 receives a preset stop command triggered by the earphone 2. When the electronic device 1 receives the preset stop command, block 305 is implemented. When the electronic device 1 does not receive the preset stop command, the electronic device 1 process the communication notification according to other commands received from the earphone 2 or the electronic device 1, and the procedure ends.

In block 305, the control module controls the electronic device 1 to stop outputting of the preset voice prompt of the communication notification via the earphone 2 and returns to an original status of the electronic device 1. In one embodiment, the control module can exit a preset notification interface of the communication notification displayed on the display screen 13, and returns the original status before displaying the preset notification interface.

All of the processes described above can be embodied in, and fully automated via, functional code modules executed by one or more general purpose processors such as the processor 14. The code modules can be stored in any type of non-transitory readable medium or other storage system such as the storage system 10. Some or all of the methods can alternatively be embodied in specialized hardware. Depending on the embodiment, the non-transitory readable medium can be a hard disk drive, a compact disc, a digital versatile disc, a tape drive, or other storage medium.

The described embodiments are merely examples of implementations, and have been set forth for a clear understanding of the principles of the present disclosure. Variations and modifications may be made without departing substantially from the spirit and principles of the present disclosure. All such modifications and variations are intended to be included within the scope of this disclosure and the described inventive embodiments, and the present disclosure is protected by the following claims and their equivalents.

What is claimed is:

1. A computer-implemented method for controlling communication notifications of an electronic device, the method comprising:
searching an address book of the electronic device for confirming identity information for a sender device when the electronic device receives a communication notification from the sender device;
confirming voice data of the sender device corresponding to confirmed identity information of the sender device using a voice database of the electronic device;
outputting a preset voice prompt for the communication notification via an earphone of the electronic device according to confirmed voice data and a preset prompt ring corresponding to the communication notification; and
controlling the electronic device to stop outputting the preset voice prompt of the communication notification via the earphone, when the electronic device receives a preset stop command triggered by the earphone.

2. The method according to claim 1, wherein the identity information is confirmed by:
extracting a phone number of the sender device from the communication notification;
comparing the extracted phone number with phone numbers in the address book, and determining whether the extracted phone number matches a specified phone number in the address book;
confirming a name corresponding to the specified phone number in the address book as the identity information of the sender device if the extracted phone number matches the specified phone number in the address book; and
confirming the extracted phone number as the identity information of the sender device if no phone number in the address book matches the extracted phone number.

3. The method according to claim 1, wherein the preset voice prompt comprises outputting the voice data of the identity information of the sender device and preset voice keywords of the communication notification with the preset prompt ring corresponding to the communication notification.

4. The method according to claim 1, wherein the earphone comprises a plurality of keystrokes and/or virtual icons, and the preset stop command is trigged by a specified keystroke or icon, or by a combination of keystrokes and/or irons of the earphone.

5. The method according to claim 1, further comprising:
exiting a preset notification interface of the communication notification displayed on a display screen of the electronic device and returning an original status before displaying the preset notification interface, when the electronic device receives the preset stop command triggered by the earphone.

6. The method according to claim 1, wherein the voice database stores voice files corresponding to numbers including 0-9 and characters, and name-voice files corresponding to names.

7. A non-transitory computer-readable storage medium storing a set of instructions, when executed by at least one processor of an electronic device, cause the at least one processor to perform a method for controlling communication notification of the electronic device, the method comprising:
searching an address book of the electronic device for confirming identity information for a sender device when the electronic device receives a communication notification from the sender device;
confirming voice data of the sender device corresponding to confirmed identity information of the sender device using a voice database of the electronic device;
outputting a preset voice prompt for the communication notification via an earphone of the electronic device according to confirmed voice data and a preset prompt ring corresponding to the communication notification; and
controlling the electronic device to stop outputting the preset voice prompt of the communication notification via the earphone, when the electronic device receives a preset stop command triggered by the earphone.

8. The storage medium according to claim 7, wherein the identity information is confirmed by:
extracting a phone number of the sender device from the communication notification;
comparing the extracted phone number with phone numbers in the address book, and determining whether the extracted phone number matches a specified phone number in the address book;
confirming a name corresponding to the specified phone number in the address book as the identity information of the sender device if the extracted phone number matches the specified phone number in the address book; and
confirming the extracted phone number as the identity information of the sender device if no phone number in the address book matches the extracted phone number.

9. The storage medium according to claim 7, wherein the preset voice prompt comprises outputting the voice data of the identity information of the sender device and preset voice keywords of the communication notification with the preset prompt ring corresponding to the communication notification.

10. The storage medium according to claim 7, wherein the earphone comprises different keystrokes and/or virtual icons, and the preset stop command can be trigged by a specified keystroke or icon, or by a combination of keystrokes and/or irons of the earphone.

11. The storage medium according to claim 7, wherein the method further comprises:
exiting a preset notification interface of the communication notification displayed on a display screen of the electronic device and returning an original status before displaying the preset notification interface, when the electronic device receives the preset stop command triggered by the earphone.

12. The storage medium according to claim 7, wherein the voice database stores voice files corresponding to numbers including 0-9 and characters, and name-voice files corresponding to names.

13. An electronic device, comprising:
a display screen;
at least one processor; and
a storage system storing one or more programs, which when executed by the at least one processor, cause the at least one processor to:
search an address book of the electronic device for confirming identity information of a sender device when the electronic device receives a communication notification of the sender device;
confirm voice data of the sender device corresponding to the confirmed identity information of the sender device using a voice database of the electronic device;
output a preset voice prompt of the communication notification via an earphone of the electronic device according to the confirmed voice data and a preset prompt ring corresponding to the communication notification; and
control the electronic device to stop outputting of the preset voice prompt of the communication notification via the earphone, when the electronic device receives a preset stop command triggered by the earphone.

14. The electronic device according to claim 13, wherein the identity information is confirmed by:
extracting a phone number of the sender device from the communication notification;
comparing the extracted phone number with phone numbers in the address book, and determining whether the extracted phone number matches a specified phone number in the address book;
confirming a name corresponding to the specified phone number in the address book as the identity information of the sender device if the extracted phone number matches the specified phone number in the address book; and
confirming the extracted phone number as the identity information of the sender device if no phone number in the address book matches the extracted phone number.

15. The electronic device according to claim 13, wherein the preset voice prompt comprises outputting the voice data of the identity information of the sender device and preset voice keywords of the communication notification with the preset prompt ring corresponding to the communication notification.

16. The electronic device according to claim 13, wherein the earphone comprises a plurality of keystrokes and/or virtual icons, and the preset stop command is trigged by a specified keystroke or icon, or by a combination of keystrokes and/or irons of the earphone.

17. The electronic device according to claim 13, wherein the one or more programs further cause the at least one processer to:
exit a preset notification interface of the communication notification displayed on a display screen of the electronic device and return an original status before displaying the preset notification interface, when the electronic device receives the preset stop command triggered by the earphone.

18. The electronic device according to claim 13, wherein the voice database stores voice files corresponding to numbers including 0-9 and characters, and name-voice files corresponding to names.
